(19) United States
(12) Patent Application Publication
(10) Pub. No.: US 2011/0246332 A1
(43) Pub. Date: Oct. 6, 2011

(54) Down Sell Method for E-Commerce

(76) Inventors: Abdulrahmen Alcodray, Dearborn, MI (US); Lori Wagner, Flat Rock, MI (US)

(21) Appl. No.: 12/824,552

(22) Filed: Jun. 28, 2010

Related U.S. Application Data
(60) Provisional application No. 61/318,877, filed on Mar. 30, 2010.

(51) Int. Cl. G06Q 30/00; G06Q 99/00

(52) U.S. Cl. 705/27.1

(57) ABSTRACT

A method and apparatus for implementing a down sell process. The method includes offering for sale a product or service and further offering a recommended accompanying products or services. When the recommended product or service is not selected for purchase along with the selected main item for purchase, providing a notice to the purchaser, where the notice may include a warning that failure to use the main product or service with the recommended products or services may result in a degradation of quality or performance, or a disclaimer of adverse effects of using the main product or service with other products or services that are not the recommended product or service, and having the purchaser acknowledge or accept the contents of the notice.

### CROSS-REFERENCE TO RELATED APPLICATIONS

This application claims priority to provisional U.S. patent application entitled “Down Sell Method for E-Commerce,” filed Mar. 30, 2010, having Ser. No. 61/318,877, now pending, the disclosure of which is hereby incorporated by reference in their entirety.

### FIELD OF THE INVENTION

The present invention relates generally to electronic commerce wherein a purchaser of a product or service is made via an electronic medium. More specifically purchasers of products and services may have multiple companion options and/or companion products or services which are recommended, but optional, for purchase along with the main item, and if the recommended item is not selected for purchase, the purchaser is provided with a notice and must acknowledge that notice in order to continue with the purchase.

### BACKGROUND OF THE INVENTION

Electronic commerce is wide spread, and a variety of people engage in electronic commerce activities constantly around the world. The sophistication of an electronic commerce purchaser may vary greatly from person to person, no matter what the product or service is being purchased. When a product or service is offered for sale or rent, often there are companion options, such as other products or services that are recommended to be purchased along with the main item. Many times the recommended item is simply a non-vital option that may compliment the main product or service. One such example occurs during the purchase of a laptop computer. Many manufactures, wholesalers, and retailers see the purchase of such an item as an opportunity to sell the purchaser the laptop computer with a few extra options. Via an electronic means, the purchaser selects an item, such as a laptop computer, and a recommendation may be made to purchase more RAM (random access memory), hard drive space, processing power, higher resolution screen, extended warranties, etc. This is an example of up selling in electronic commerce, where the purchaser is given the option to upgrade or purchase items related to the main item being purchased.

There is also the concept of cross selling employed in electronic commerce. Keeping with the laptop computer example, a purchaser may be recommended to purchase a printer, a router, a mouse and keyboard, productivity or entertainment software, etc. These recommendations are of items associated with the main item being purchased but are not part of the main item itself. So, in this example, none of the items here will affect the performance or function of the laptop computer if not purchased, however, if purchased they enhanced the use of the laptop computer.

An example of the difference between up selling and cross selling is easily made when considering software for a laptop computer. The recommendation of a superior operating system with the laptop computer, even though the laptop computer already comes with a basic operating system choice is an example of up selling. The recommendation of a productivity software package containing, for example, a word processing program, a spreadsheet program, and a slide presentation program, is an example of cross selling because it is a nonessential item that can enhance the purchaser's use of the laptop computer.

There is a need, however, for a seller to be able notify the purchaser when his selections may not meet the minimum hardware or software requirements for the intended use of the product or services by the purchaser.

### SUMMARY OF THE INVENTION

At least in view of the above, it would be desirable to provide a method and apparatus that notifies a purchaser when he has not selecting the recommended items that are associated with the purchase of a product or service and that degradation of the intended use of the product or service may occur.

The foregoing needs are met, to a great extent, by certain embodiments of the present invention. According to one such embodiment of the present invention, an apparatus for electronic commerce is provided, which can include a processor configured to execute instructions, a memory configured to store the instructions and information and communicate with the processor, an input device configured to receive commands and information and communicate with the processor, a display configured to communicate with the processor and displays a graphical user interface containing options for making purchases of a product or service, wherein a notice is displayed to the user when a recommended item associated with the product or service is not selected by a user, and a communication device to communicate information to a remote device.

In accordance with another such embodiment of the present invention, an apparatus for electronic commerce is provided, which can include a means for processing configured to execute instructions, a means for storing configured to store the instructions and information and communicate with the means for processing, a means for inputting configured to receive commands and information and communicate with the means for processing, a means for displaying configured to communicate with the means for processing and displays a graphical user interface containing options for making purchases of a product or service, wherein a means for notifying is displayed to the user when a recommended item associated with the product or service is not selected by a user, and a means for communicating configured to communicate information to a remote device.

In accordance with still another embodiment of the present invention, a method of purchasing in electronic commerce is provided, which can include displaying on a display of a computing device a product or service available for purchase, displaying on the display a recommended item associated with the product or service, determining with a processor of the computing device whether the recommended item was selected or not, displaying on the display a notice that the recommended item was not selected, and completing a sale transaction of the product or service with the processor of the computing device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a standalone apparatus for implementing down selling in electronic commerce according to an embodiment of the invention.

FIG. 2 is a schematic diagram of a networked system for implementing down selling in electronic commerce according to an embodiment of the invention.

FIG. 3 is a flow diagram of a method for implementing down selling in electronic commerce according to an embodiment of the invention.

### DETAILED DESCRIPTION

An embodiment of the invention for implementing down selling in electronic commerce may provide an apparatus for a purchaser to interact with to execute a purchase through an electronic commerce medium, such as the internet. That apparatus may be a standalone apparatus, such as a kiosk in a mall or in a store where one might place an order to receive of product, or a self-checkout station in a store. Such a standalone apparatus may be preloaded with the necessary software and data needed to implement down selling, and the software and data may be updated a variety of ways.

A further embodiment may provide for a system including networked components where one component provides a purchaser interface to make the purchase, and another component of the system handles providing the software and/or data to implement the down selling.

In one embodiment of the invention, down selling may include a notice, such as a warning, to the purchaser that the selections made of certain components or services of the main product or services do not match the recommendations by the seller of the main service or product and that the quality or performance of the product or service being purchased will be negatively affected or diminished as a result of the selected components or services and may not fulfill the expectations of the purchaser. In addition, receipt of an explicit acknowledgement of the performance degradation may be required to allow the purchase. For example, a diagnostic software may require a minimum 4GB of memory to work optimally, and the purchaser selects a 2GB memory for the diagnostic tool (being purchased) to be used with the software, then a notice may be provided to the purchaser. In another example, if an optimization service (for optimizing the diagnostic tool after a period of time) is recommended by the seller and the purchaser does not selected it, then the diagnostic tool may not run optimally without the optimizing service. Thus during down selling, a seller may require the purchaser to acknowledge that he understands that there may be a degradation of the quality or performance of the product due to his selection of less memory or not purchasing the optimizing service, but that he still desires to continue with the purchase of the product.

In still another embodiment of the implementation of down selling may provide the purchaser with alternative options. The purchaser may be presented with a notice, such as the one described above, and the purchaser may be provided with options to replace the recommended components with less costly, differently branded, or differently equipped components that may still result in a degradation of quality and performance, but may mitigate the extent of that degradation. Alternatively, the seller may prevent the purchaser from purchasing that particular selected component because it does not meet the minimum hardware and/or software requirement for the intended use of the product.

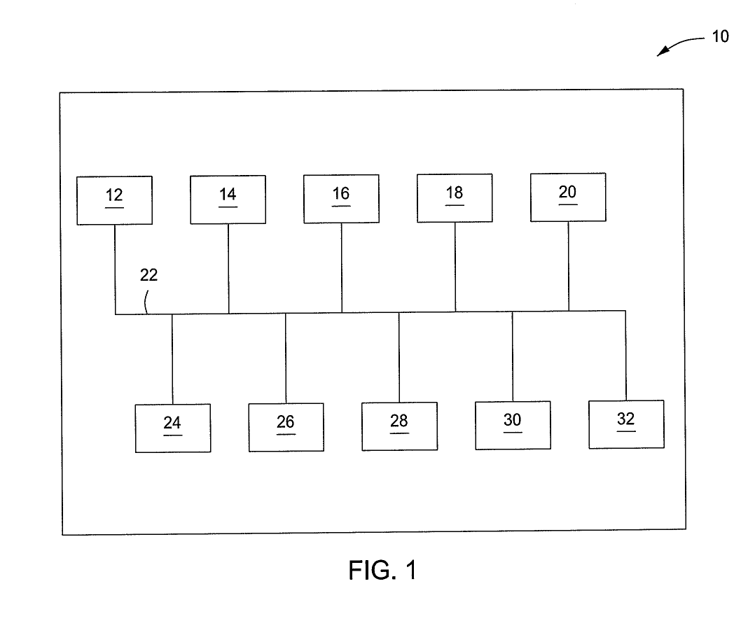

The invention will now be described with reference to the drawing figures, in which like reference numerals refer to like parts throughout. FIG. 1 is a block diagram of a standalone apparatus for implementing down selling in electronic commerce according to an embodiment of the invention. One such apparatus may be a purchasing device 10.

The purchasing device 10 may include an input device 12, a memory 14, a communication device 16, a processor 18, and a display 20, some or all of which can be interconnected by a data link 22. The purchasing device 10 may further include a number of modules designed to execute certain functions. Such modules may include an order module 24, a compare module 26, a notice module 28, an alternatives module 30, and a sale module 32. In one embodiment, the modules may be software modules in nature.

The computing device 10 can be a general computing device, such as a personal computer (PC), a UNIX workstation, a laptop, a server, a mainframe computer, a vehicle diagnostic tool, a personal digital assistant (PDA), a cellular phone, a smartphone, or some combination of these. Alternatively, the purchasing device 10 can be a specialized computing device made up of components specifically chosen to execute the functionality of the purchasing device 10, such as a kiosk or specialized handheld devices for use in a store. The remaining components can include programming code, such as source code, object code or executable code, stored on a computer-readable medium that can be loaded into the memory 14 and processed by the processor 18 in order to perform the desired functions of the computing device 10.

The processor 18 may be executed in different ways for different embodiments of the purchasing device 10. One option is that the processor 18 is a device that can read and process data such as a program instruction stored in the memory 14 or received from an external source. Such a processor 18 may be embodied by a microcontroller. On the other hand, the processor 18 may be a collection of electrical circuitry components built to interpret certain electrical signals and perform certain tasks in response to those signals, or the processor may be an integrated circuit, field programmable gate array (FPGA) or ASIC.

The memory 14 may include, for example, any form or combination of volatile, non-volatile, solid state, magnetic, optical, permanent, removable, writable, rewriteable, and read-only memory. The memory 14 may contain a number of program instructions for use with the purchasing computer 10. The instructions may include steps, for example, for comparing the selected components for purchase by the purchaser to the recommended components to purchase by the seller for the intended use of the product or services. The product may be a diagnostic tool for use to test a vehicle or a diagnostic software to be used in said diagnostic tool. These steps may include providing a notice when the components selected for purchase by the purchaser do not match the recommended items by the seller for the intended use and providing alternative recommended components. Many other embodiments may provide for further steps, some of which will be discussed herein.

Additionally, an embodiment of the purchasing device 10 can communicate information to a user through the display 20 and request user input through the input device 12 by way of an interactive, menu-driven, visual display-based user interface, or graphical user interface (GUI). The user may interactively input information using direct manipulation of the GUI. Direct manipulation can include the use of a pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a scroll wheel, a touch screen or a voice-activated system.

Some options that may be selected through GUI via the input device 12 may allow the user control over what products and services are being purchased. The user may, for example, select which products and services, the quantity of each product or service, the method of payment, and the timing and method of delivery for each product or service. The user may also select or deselect the recommended components and services to be purchased along with the main products or services being purchased. The input device 12 may also allow a user to acknowledge awareness of the consequences of not purchasing recommended components or purchasing alternative, cheaper recommended components, or decline to make the purchase in light of receiving notice of those consequences.

The display 20 may have various different implementations. Examples of such a display may be any standard or high resolution display. Variety of options are available to implement the display, such as, a cathode ray tube screen, a projection screen, a liquid crystal display screen, a plasma screen, or organic light emitting diode screen. The display 20 may be touch sensitive such that the user may interact with the GUI by contact with the display 20. It is also possible that the display 20 is capable of two-dimensional and/or three-dimensional display.

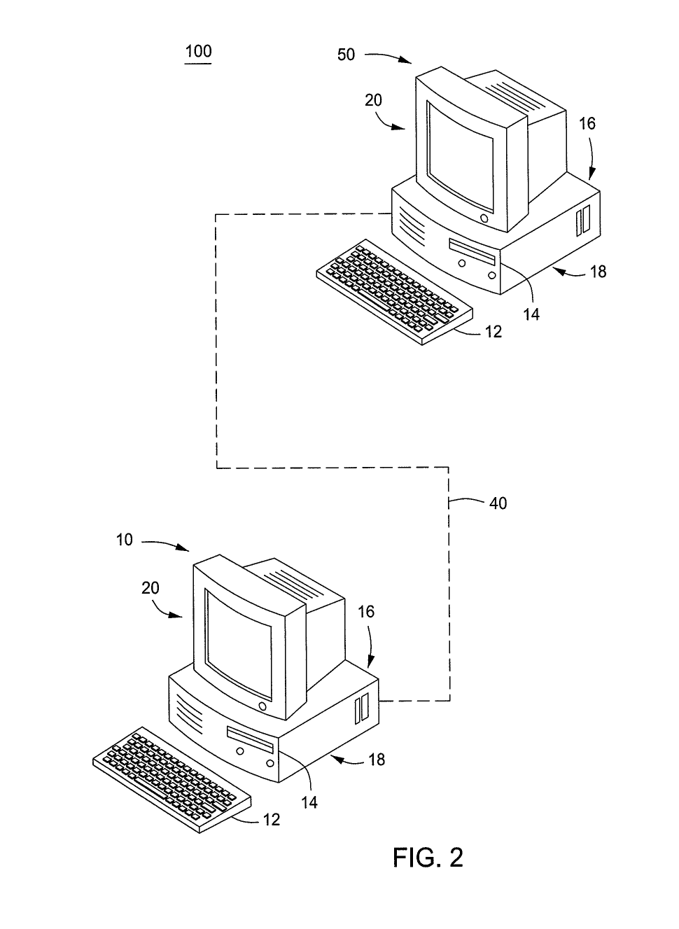

In various embodiments, the purchasing device 10 can be coupled to a communication network 40 (FIG. 2). The communication network 40 allows for communication between the purchasing device and other devices. The purchasing device 10 can be coupled to the communication network 40 by way of the communication device 16 which in various embodiments can incorporate any combination of devices—as well as any associated software or firmware—configured to couple processor-based systems. Such communication devices 16 may include modems, network interface cards, serial buses, parallel buses, LAN or WAN interfaces, wired, wireless or optical interfaces, and the like, along with any associated transmission protocols, as may be desired or required by the design. One use for the communication device 16 is to link to portable media such as a flash drive, CD drive, DVD drive, or any other portable storage media for updating data and software of the purchasing device 10.

The purchasing device 10 may further include a number of modules that provide different functionality for the purchasing device. One such module may be the order module 24. The order module 24 may allow the purchaser select the desired options. Principally, those options may include the product or service to be purchased, and any recommended components or services associated with the main item for purchase. This selection of recommended components may be implemented differently on various purchasing devices 10. For example, one embodiment may simply show the recommend components or services and allow the purchaser to either select recommended components or services which the purchaser desires, or ignore some or all of the recommended components or services. Other embodiments may present the purchaser with recommended components or services preselected requiring the purchaser to deselect some or all of the recommended components or services which are not desired, or simply accept all of the preselected components or services. The recommended components or services displayed or preselected may include simply the most recommended components or services associated with the item or services being purchased. This does not have to be limited to one recommended component or service as there may be multiple recommended items serving different purposes and may all be the most recommended components or service for a particular purpose associated with the main product or service being purchased.

Alternatively, multiple recommended components may be displayed for each purpose, and the order in which they are displayed or if one of a group of recommended components or services is preselected may be based on the rank of recommendation of the recommended component or service (this will be further explained with reference to the alternatives module 30).

The compare module 26 may be another module included in the purchasing device 10. The compare module 26 allows for the purchasing device 10 to determine if the purchaser is selecting all, some, or none of the recommended components or services. If the purchaser has selected all or some of the recommended components or services, the compare module 26 may determine if the recommended components or services chosen are of the highest recommended class or of a lesser recommended class or even the least recommended class. The compare module 26 may accomplish this by comparing the selected recommended components to previous predetermined stored components data (in a database) indicating the recommendation rank of the selected recommended components. Alternatively, the selected recommended components may have the rank data tied to the selection and the compare module 26 can determine what the recommendation rank is directly from the selections. The compare module 26 may then inform the notice module 28 of the rank of the recommended components that were selected.

The notice module 28, which may be included in the purchase device 10, may present a notice through the display 20. The notice may be prompted by the information that the purchaser has selected recommended components or services which have a recommendation rank below the highest rank, or if recommended components or services were not selected by the purchaser. Such a notice may include: (1) a warning of the degradation of quality or performance of the intended use of the product or service; (2) a disclaimer for any adverse results for using the purchased product or service without the recommended components or with other non recommended components; (3) a notice that the recommended components were not selected; (4) an option to change the selections made; (5) an option to proceed by acknowledging and accepting the contents of the notice; and (6) an option to select alternative recommended items, which may be offered at a lower price, of a different brand or be differently equipped, and/or an option to cancel the purchase. Further any of the proceeding notice can be presented in combination to the user.

The notice may be in the form of a text dialog box that is displayed on a display. The notice may be made noticeable on the display through various schemes, such as different font type, font color, font size, size of dialog box, color of the dialog box, flashing dialog box. The notice may be acknowledged through a click on the dialog box or a radio button on the screen by the purchaser. The notice may also be in the form of audible alert (beep) or other visual alert to the purchaser.

The notice may be displayed at various times during the purchasing period such as after a non recommended component or service is selected, when the main product or service is added to cart with the non recommended component or service, or during check out of the main product or service.

The alternatives module 30, as noted above, may be included in the purchase device 10. The alternatives module 30 may be able to determine alternatives to the highest ranking recommended components or services that may be characterized by a lower price, a different brand, or different component or service. The alternatives to the highest ranking recommended components or services may be offered to the purchaser at a variety of different times in the process of purchasing a product or service. Alternative recommended products or services may be presented at the same time as when the user is selecting the main product or service, or at any time when the highest recommended item is offered. The alternatives may also be offered as part of one of the notices displayed to the purchaser if the highest recommended item has not been selected, or as the user is completing the purchase as a last opportunity to complete the order together when the highest recommended component or service has not been selected.

Another module which may be included in the purchasing device 10 is the sale module 32. This sale module 32 completes the sale transaction by accepting and verifying payment information. Other functions of the sale module 32 may be to give the purchaser a last opportunity to purchase recommended products or services not previously selected.

The various modules discussed herein may be stored on the purchase device 10 or stored remotely from it. If stored remotely, the communication device 16 may be used to communicate with a remote device that contains the various modules.

Referring now to FIG. 2, a schematic diagram of a networked system for implementing down selling in electronic commerce according to an embodiment of the invention is depicted. One such system may be the recommendation system 100. The recommendation system 100 may include the purchasing device 10, as previously described, and a selling device 50.

Much like the previous described purchasing device 10, the selling device 50, according to an embodiment of the invention, may include the input device 12, the memory 14, the communication device 16, the processor 18, and the display 20, some or all of which can be interconnected by a data link 22 (not shown). The selling device 50 may further include a number of modules designed to execute certain functions. Such modules may include the order module 24, the compare module 26, the notice module 28, the alternatives module 30, and the sale module 32 as previously discussed. Alternatively, these modules may be stored and accessed remotely similar to an embodiment of the purchasing device

The input device 12, the memory 14, the communication device 16, the processor 18, and the display 20 may all have similar structural features to the same items previously described. However, in some embodiments, the functions of these items may vary compared to their implementations as part of the purchasing device.

Regarding the input device 12, it may be used in the selling device 50 for updating the software and data, stored on the purchasing device 10 or the selling device 50.

The display device 20 may be used by the selling device 50 to display activity on the purchasing device 10 connected to the selling device 50. Other uses for the display device 20 on the selling device may be to display historical data of purchases made and related data about the purchases of recommended products and services, potentially divided by purchases of recommended components or services before the purchaser received a notice and after the purchaser received a notice.

In one embodiment, shown in FIG. 2, there is both the purchasing device 10 and the selling device 50 and the communication network 40 links the communication devices 16 of the purchasing device 10 and the selling device 50 with other devices, and with each other. Various embodiments of the communication network may include any viable combination of devices and systems capable of linking computer-based systems, such as USB; Bluetooth; WiFi; ZigBee; power line communication (PLC); home area network (HAN); Silver Spring network; stable election protocol (SEP); the Internet; TCP/IP; an intranet or extranet; a local area network (LAN); a wide area network (WAN); a direct cable connection; a private network; a public network; an Ethernet-based system; a token ring; a value-added network; a telephony-based system, including, for example, T1 or E1 devices; a cellular telephony system, for example, GPRS or GSM; an Asynchronous Transfer Mode (ATM) network; a wired system; a wireless system; an optical system; a combination of any number of distributed processing networks or systems or the like.

By virtue of the communication network 40 connecting the purchasing device 10 to the selling device 50, information may pass back and forth between the two devices 10, 50. One embodiment may provide for the selling device 50 to have the ability to provide the purchasing device 10 with updated software and data. Further embodiments may allow for some or all of the modules 26, 28, 30, 32 (FIG. 1) to reside on the purchasing device 50. When any of the modules 26, 28, 30, 32 reside on the purchasing device 50, the processes of that module 26, 28, 30, 32 are run as server side processes, as opposed to the client side processes as described above when the modules 26, 28, 30, 32 reside on the purchasing device 10.

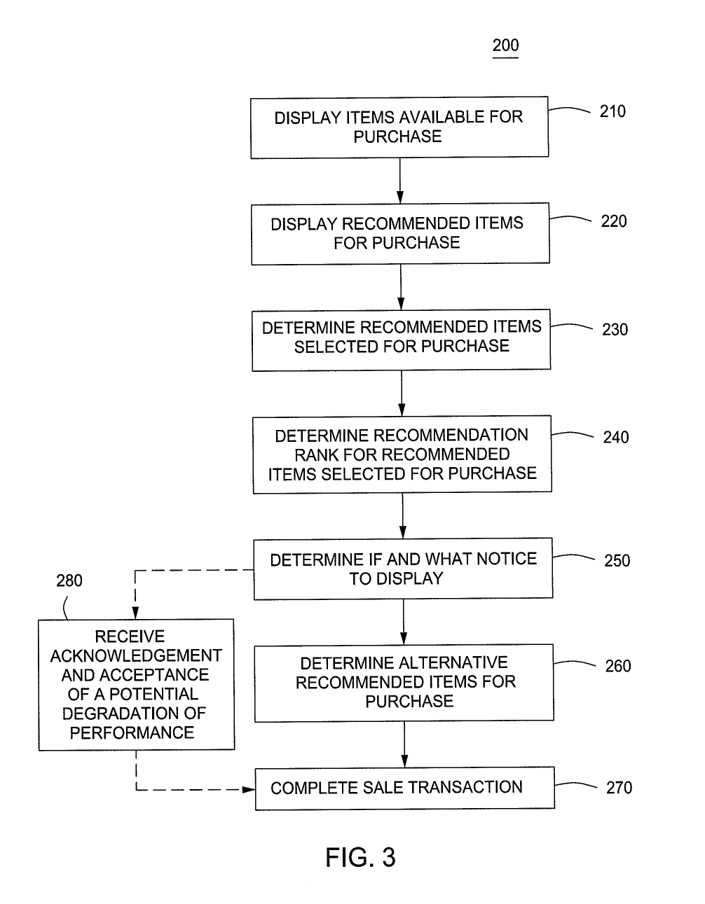

Referring now to FIG. 3, depicted is a flow diagram of a method for implementing down selling in electronic commerce according to an embodiment of the invention. One such method many be a down sell method 200.

The down sell method 200 commences when items available for purchase are displayed (step 210). A purchaser may select a product or service to be purchased. At this point the recommended products and services to accompany the main item selected for purchase may be displayed (step 220). In displaying these recommended items, one embodiment may simply show the recommend products or services and allow the purchaser to either select recommended items which the purchaser desires, or ignore some or all of the recommended items. Other implementations may present the purchaser with recommended products or services preselected requiring the purchaser to deselect some or all of the recommended items which are not desired, or simply accept some or all of the preselected items. The recommended items displayed or preselected may include simply the most recommended products or services associated with the item or service being purchased. This does not have to be limited to one recommended product or service as there may be multiple recommended items serving different purposes and may all be the most recommended product or service for a particular purpose associated with the main product or service being purchased. Alternatively, multiple recommended items may be displayed for each purpose, and the order in which they are displayed, or if one of a group of recommended items is preselected, may be based on the rank of recommendation of the recommended product or service.

After the display and selection of the main product or service to be purchased and, the display and selection, or omission of selection, of any recommended products or services, a determination is made if the purchaser is selecting all, some, or none of the recommended products or services (step 230). If the purchaser has selected all or some of the recommended items, a determination is made if the recommended items chosen are of the highest recommended class or of a lesser recommended class or the least recommended class (step 240). This determination may accomplish by comparing the selected recommended items to stored data indicating the recommendation rank of the selected recommended items. Alternatively, the selected recommended items may have the rank data tied to the selection and the determination of what the recommendation rank is can be made directly from the selections.

Following and depending on the determinations made in the previous steps a notice may be presented (step 250). The notice may be prompted by the information that the purchaser has selected recommended items which have a recommendation rank below the highest rank, or if a recommended item was not selected by the purchaser. Such a notice may include: (1) a warning of the degradation of quality or performance of the product or service; (2) a disclaimer for any adverse results for using the purchased product or service without the recommended items or with other items; (3) a notice that recommended items were not selected; (4) an option to change the selections made; (5) an option to proceed acknowledging and accepting the contents of the notice; (6) an option to select alternative recommended items, which may be offered at a lower price, of a different brand or be differently equipped; (7) and/or an option to cancel the purchase.

Further, if a notice is required based on the determinations made in the previous steps, another determination may be made as to the alternatives to the highest ranking recommended items that may be offered to the purchaser (step 260). Such alternatives may be characterized by a lower price, a different brand, or different equipment or service. The alternatives to the highest ranking recommended items may be offered to the purchaser at a variety of different times throughout the down sell method 200. Alternative recommended products or services may be presented at the same time as when the user is selecting the main product or service, or at any time when the highest recommended item is offered. The alternatives may also be offered as part of one of the notices displayed to the purchaser if the highest recommended item has not been selected, or as the user is completing the purchase as a last opportunity to complete the order together when the highest recommended item has not been selected.

Alternatively, if a notice indicating performance degradation is desired based on the determinations made in the previous steps, that notice (step 250) may include an option to proceed acknowledging and accepting the contents of the notice. Upon receipt of the acknowledgement and acceptance of the potential performance degradation due to purchasing and using a component other than the component recommended (step 280), no further determinations may be necessary.

Once the user has completed selecting all of the desired products and acknowledged any notices, if necessary, the sale transaction may be completed by accepting and verifying payment information (step 270). The purchaser may be given a last opportunity to purchase recommended products or services not previously selected prior to the completion of the sale transaction.

In this regard, FIGS. 1, 2, and 3 depict the apparatus, systems, and methods of various embodiments potentially including a general-purpose computer by which the embodiments of the present invention may be implemented. Those of ordinary skill in the art will appreciate that a computer can include many more components than those described herein. However, it is not necessary that all of these generally conventional components be shown in order to disclose an illustrative embodiment for practicing the invention. The general-purpose computer can include a processing unit, and a system memory, which may include random access memory (RAM) and read-only memory (ROM). The computer also may include nonvolatile storage memory, such as a hard disk drive, where additional data can be stored.

An embodiment of the present invention can also include one or more input devices, such as a mouse, keyboard, and the like. A display can be provided for viewing text and graphical data, as well as a user interface to allow a user to request specific operations. Furthermore, an embodiment of the present invention may be connected to one or more remote computers via a communication device. The connection may be over a communication network 40, such as a local area network (LAN) wide area network (WAN), and can include all of the necessary circuitry for such a connection.

Typically, computer program instructions, such as portions of the down sell method 200, may be loaded onto the computer or other general purpose programmable machine to produce a specialized machine, such that the instructions that execute on the computer or other programmable machine create means for implementing the functions specified in the flowchart. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the flowchart. Further, the steps of the flowchart should not be limited to the order as described and depicted herein. The steps of the flowchart may be arranged in various different arrangements.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the flowchart steps.

Accordingly, steps of the flowchart support combinations of means for performing the specified functions, combinations of steps for performing the specified functions and program instruction means for performing the specified functions. It will also be understood that each step of the flowchart, as well as combinations of steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for electronic commerce, comprising:
a processor configured to execute instructions;
a memory configured to store the instructions and information and communicate with the processor;
an input device configured to receive commands and information and communicate with the processor;
a display configured to communicate with the processor and displays a graphical user interface containing options for making purchases of a product or service, wherein a notice is displayed to the user when a recommended item associated with the product or service is not selected by a user; and
a communication device to communicate information to a remote device.

2. The apparatus of claim 1, wherein the user acknowledges the notice that the recommended item was not selected.

3. The apparatus of claim 1, wherein the notice is a dialog box that informs the user of a consequence of not selecting the recommended item.

4. The apparatus of claim 1, wherein memory includes an order module.

5. The apparatus of claim 1, wherein the memory includes a compare module.

6. The apparatus of claim 1, wherein the memory includes a notice module.

7. The apparatus of claim 1, wherein the memory includes an alternative module.

8. The apparatus of claim 1, wherein the memory includes a sales module.

9. The apparatus of claim 5, wherein the compare module determines if the selected items are of a certain previously ranked class of items.

10. The apparatus of claim 7, wherein the alternative module provides alternative items to the recommended items to the user.

11. The apparatus of claim 3, wherein the consequence is a degradation of the intended use of the product or service.

12. An apparatus for electronic commerce, comprising:
a means for processing configured to execute instructions;
a means for storing configured to store the instructions and information and communicate with the means for processing;
a means for inputting configured to receive commands and information and communicate with the means for processing;
a means for displaying configured to communicate with the means for processing and displays a graphical user interface containing options for making purchases of a product or service, wherein a means for notifying is displayed to the user when a recommended item associated with the product or service is not selected by a user; and
a means for communicating configured to communicate information to a remote device.

13. The apparatus of claim 12, wherein the user acknowledges the means for notifying that the recommended item was not selected.

14. The apparatus of claim 12, wherein the means for notifying is a dialog box that informs the user of a consequence of not selecting the recommended item.

15. The apparatus of claim 12, wherein memory includes an order module.

16. The apparatus of claim 12, wherein the means for storing includes a compare module.

17. The apparatus of claim 12, wherein the means for storing includes a notice module.

18. The apparatus of claim 12, wherein the means for storing includes an alternative module.

19. The apparatus of claim 12, wherein the means for storing includes a sales module.

20. The apparatus of claim 16, wherein the compare module determines if the selected items are of a certain previously ranked class of items.

21. The apparatus of claim 18, wherein the alternative module provides alternative items to the recommended items to the user.

22. The apparatus of claim 14, wherein the consequence is a degradation of the intended use of the product or service.

23. A method of purchasing in electronic commerce, comprising:
displaying on a display of a computing device a product or service available for purchase;
displaying on the display a recommended item associated with the product or service;
determining with a processor of the computing device whether the recommended item was selected or not;
displaying on the display a notice that the recommended item was not selected; and
completing a sale transaction of the product or service with the processor of the computing device.

24. The method of purchasing of claim 23 further comprising:
displaying on the display an alterative item if the recommended item was not selected.

25. The method of purchasing of claim 24 further comprising:
determining with the processor a predetermined rank of the item selected.

26. The method of purchasing of claim 23 further comprising:
displaying on the display a notice warning of a degradation of performance associated with using an item other than the recommended item; and
receiving an acknowledgement and acceptance of the notice of the degradation of performance.
